(19) United States
(12) Patent Application Publication
(10) Pub. No.: US 2016/0261388 A1
(43) Pub. Date: Sep. 8, 2016

(54) A MULTIPLE USER COMMUNICATION NETWORK

(71) Applicant: UNIVERSITY OF UTAH RESEARCH FOUNDATION, Salt Lake City, UT (US)

(72) Inventor: Behrouz FARHANG-BOROUJENY, Salt Lake City, UT (US)

(21) Appl. No.: 15/037,009

(22) PCT Filed: Nov. 25, 2014
(86) PCT No.: PCT/US14/67323

§ 371 Date: May 16, 2016

Related U.S. Application Data
(60) Provisional application No. 61/908,441, filed on Nov. 25, 2013.

(51) Int. Cl. H04L 5/00; H04B 7/04

(52) U.S. Cl. CPC H04L 5/0037; H04B 7/0452; H04L 5/005; H04L 5/0062

(57) ABSTRACT

A multi-user network including a plurality of individual terminals, wherein each individual terminal includes a terminal receiver/transmitter, and a base station including a plurality of base station receiver/transmitters, wherein the number of base station receiver/transmitters is greater than the number of individual terminals. The base station is configured to communicate simultaneously with the plurality of individual terminals over a plurality of channels, filter the signal components, and combine the signal components. The plurality of channels each include a signal component. Each channel corresponds to an individual terminal. Combining the plurality of signal components results in a substantially flat gain.

### RELATED APPLICATIONS

The present application claims priority to U.S. Provisional Application 61/908,441, filed Nov. 25, 2013, the entire contents of which are incorporated herein by reference.

### BACKGROUND

The present invention relates to wireless communications, and more specifically, to multiple-input and multiple-output (MIMO) wireless communications.

MIMO networks typically include the use of multiple transmitting antennas (e.g., terminals or transducers) and multiple receiving antennas (e.g., terminals or transducers).

Massive MIMO networks are forms of MIMO networks, and typically include a number of terminals, which is less than the number of antennas, or transducers, located at a base station. Massive MIMO is a multiuser technique where the spreading gains for each user are determined by the channel gains between the respective mobile terminal antenna and the multiple antennas at the base station. By increasing the number of antennas at the base station, the processing gain can be increased arbitrarily large. As the number of base station antennas tends to infinity, the processing gain of the system tends to infinity and, as a result, the effects of both noise and multi-user interference are completely removed.

### SUMMARY

In one embodiment, this disclosure provides a multi-user network including a plurality of individual terminals, wherein each individual terminal includes a terminal receiver/transmitter, and a base station including a plurality of base station receiver/transmitters, wherein the number of base station receiver/transmitters is greater than the number of individual terminals. The base station is configured to communicate simultaneously with the plurality of individual terminals over a plurality of channels, filter the signal components, and combine the signal components. Each of the plurality of channels includes a signal component. Each channel corresponds to an individual terminal Combining the plurality of signal components results in a substantially flat gain.

In another embodiment, this disclosure provides a multi-user network including a plurality of individual terminals and a base station. Each individual terminal includes a terminal receiver/transmitter. The base station includes a plurality of base station receiver/transmitters, wherein the number of base station receiver/transmitters is greater than the number of individual terminals. Communication between the plurality of individual terminals and the base station is encoded using a filter bank multicarrier method.

In another embodiment, this disclosure provides a multi-user network including a plurality of individual terminals and a base station. Each individual terminal includes a terminal sensor. The base station includes a plurality of base station sensors, wherein the number of base station sensors is greater than the number of individual terminals. The base station is configured to communicate simultaneously with the plurality of individual terminals over a plurality of channels, filter the signal components, and combine the signal components. The plurality of channels each including a signal component. Each channel corresponds to an individual terminal Combining the plurality of signal components results in a substantially flat gain.

In another embodiment, this disclosure provides a multi-user network including a plurality of individual terminals and a base station. Each individual terminal includes a terminal sensor. The base station includes a plurality of base station sensors, wherein the number of base station sensors is greater than the number of individual terminals. Communication between the plurality of individual terminals and the base station is encoded using a filter bank multicarrier method.

Other embodiments provided by this disclosure will become apparent by consideration of the detailed description and accompanying drawings.

### BRIEF DESCRIPTION OF THE DRAWINGS

FIG. 1 is a block diagram illustrating a network according to aspects of the present disclosure.

FIG. 2 is a flow chart illustrating an operation of the network of FIG. 1.

FIG. 3 is a block diagram illustrating a filter bank multicarrier technique used in accordance with the network of FIG. 1.

FIG. 4A illustrates a spectrum of baseband data streams.

FIG. 4B illustrates a cosine modulated multitone spectrum.

FIG. 5 is a flowchart illustrating a demodulation operation used in conjunction with the network of FIG. 1.

FIG. 6 illustrates a spectrum of a subcarrier of a cosine modulated multitone signal after demodulation to baseband.

FIG. 7 is a block diagram illustrating a network according to another embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

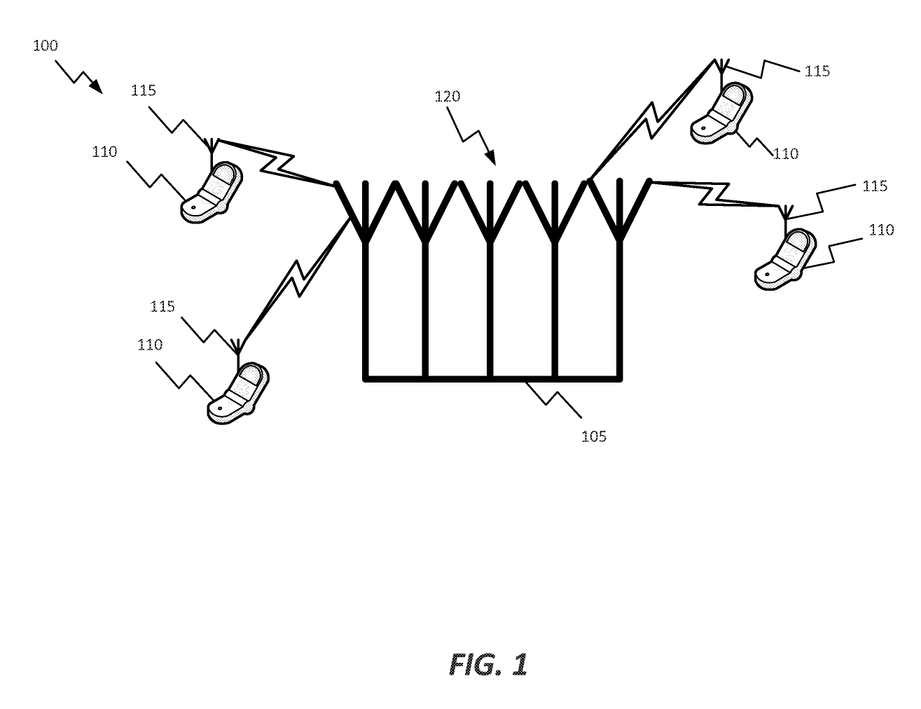

FIG. 1 illustrates a network 100, such as, but not limited to, a multi-user cellular network. The network 100 includes a base station 105 and a plurality of terminals, mobile terminals, or individual terminals, 110. Although the network 100 is illustrated as having a single base station 105 and a plurality of terminals 110, in some embodiments, the network 100 includes a plurality of base stations 105 and a plurality of terminals 110, which make up individual cells. In such an embodiment, a first cell may include a first base station 105 and a first plurality of terminals 110, while a second cell may include a second base station 105 and a second plurality of terminals 110.

The terminals 110 are configured to communicate with the base stations 105. In some embodiments, the terminals 110 may be a plurality of cellular devices, such as but not limited to, cellular telephones, or any other computing device operable to communicatively connect to a cellular network. In another embodiment, the terminals 110 may be a plurality of hydrophones, or other receiving sensors. Each terminal 110 includes, among other things, a terminal receiver/transmitter 115. In some embodiments, the terminal receiver/transmitter 115 is an antenna, such as but not limited to, a cellular antenna.

The base station 105 includes a plurality of base station receiver/transmitters 120. In some embodiments, the base station receiver/transmitters 120 are antennas, such as, but not limited to, cellular antennas. As illustrated, the number of base station receiver/transmitters 120 are greater than the number of individual terminals 110, and thus, the number of terminal receiver/transmitters 115. Although illustrated as being only slightly greater, in some embodiments, there may be approximately many tens to many hundreds more base station receiver/transmitters 120 than there are individual terminals 110, and thus, terminal receiver/transmitters 115.

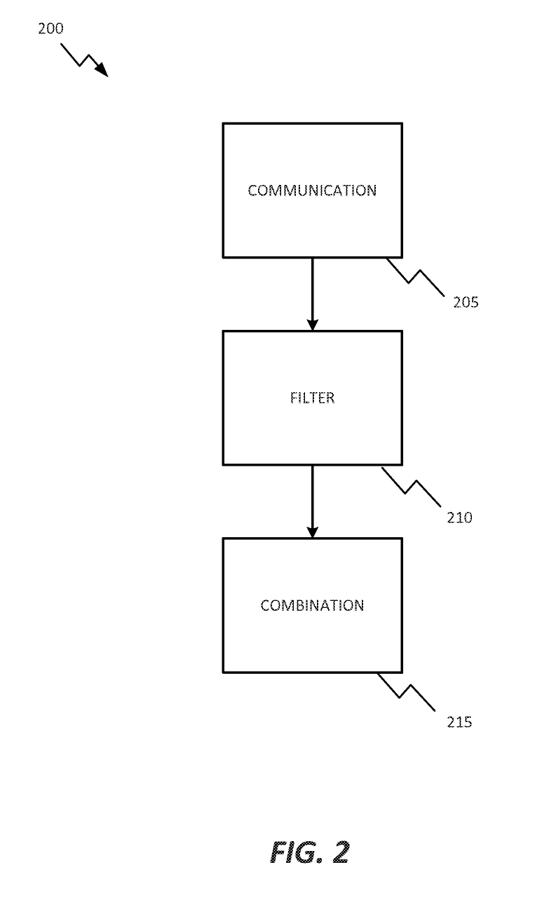

FIG. 2 is a flow chart illustrating an operation 200 of the network 100. The operation 200 includes a communication (Step 205), a filter (Step 210), and a combination (Step 215). Although illustrated as occurring in a sequential order, it should be understood that the order of the steps discloses in operation 200 may vary. Furthermore, additional steps may be included in the operation 200 and not all of the steps may be required. Although discussed in more detail below, generally, the base station 105 communicates simultaneously with the plurality of individual terminals 110 over a plurality of channels (Step 205). Signal components of the channels are filtered (Step 210). After being filtered, the signal components are combined (Step 215). In some embodiments, the signal components are linearly combined. Linearly combining the signal components results in a substantially flat gain.

During communication (Step 205), the base station 105 communicates simultaneously with the plurality of individual terminals 110. The base station 105 and individual terminals 110 communicate over a plurality of channels, or subcarriers. In some embodiments, each channel corresponds to an individual terminal 110. Each channel may include a signal component. The signal component may be a narrow subchannel.

During filtering (Step 210), the signal components are filtered. The signal component is filtered by the base station 105. In some embodiments, the filtering (Step 210) includes a filter bank multicarrier (FBMC) technique.

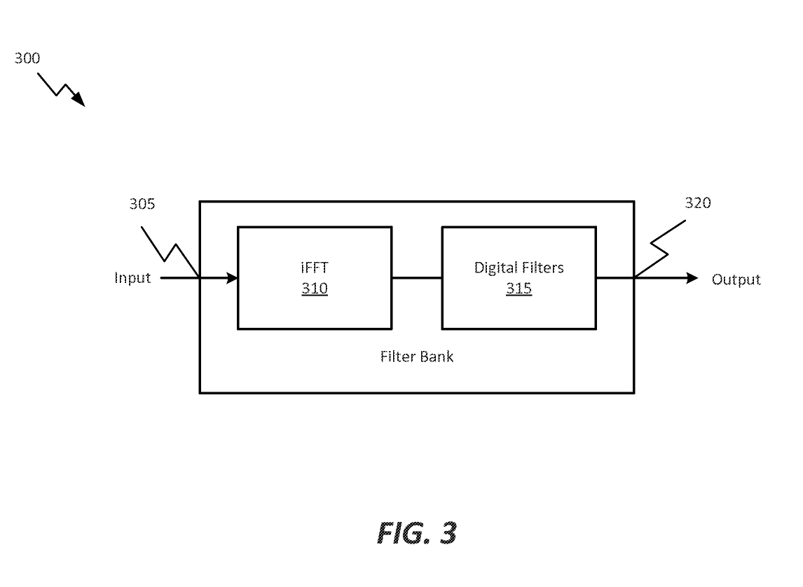

FIG. 3 illustrates an embodiment of an FBMC transmitter 300. For example, a signal component is received at input 305. An inverse fast Fourier transform (iFFT) 310 is applied to the signal component. Digital filters 315 are then applied to the subcarriers. The subcarriers are then output via output 320.

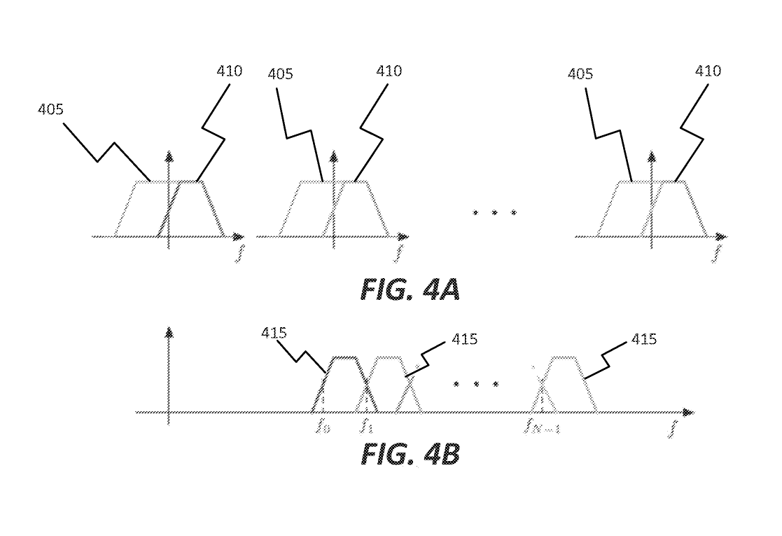

In some embodiments, the FBMC technique, or method, includes cosine modulated multitone (CMT). FIG. 4 illustrates one embodiment of a CMT modulation process. In CMT, a set of pulse amplitude modulated (PAM) baseband data streams are vestigial side-band (VSB) modulated and placed at different subcarriers. In order to allow separation of the data symbols, at a receiver end (i.e., a receiver end of the base station 105 or a receiver end of an individual terminal 110), the carrier phase of the VSB signals are toggled between 0 and π/2 among adjacent subcarriers. FIG. 4A illustrates a spectrum of baseband data streams 405, such as but not limited to PAM baseband data streams, and the VSB modulated portion 410. FIG. 4B illustrates a CMT spectrum, according to aspects of the present disclosure, including modulated versions of the VSB spectrum of baseband data streams 415. In some embodiments, the VSB signals are modulated to the individual subcarrier frequencies (f₀, f₁, . . . , f_{N-1}).

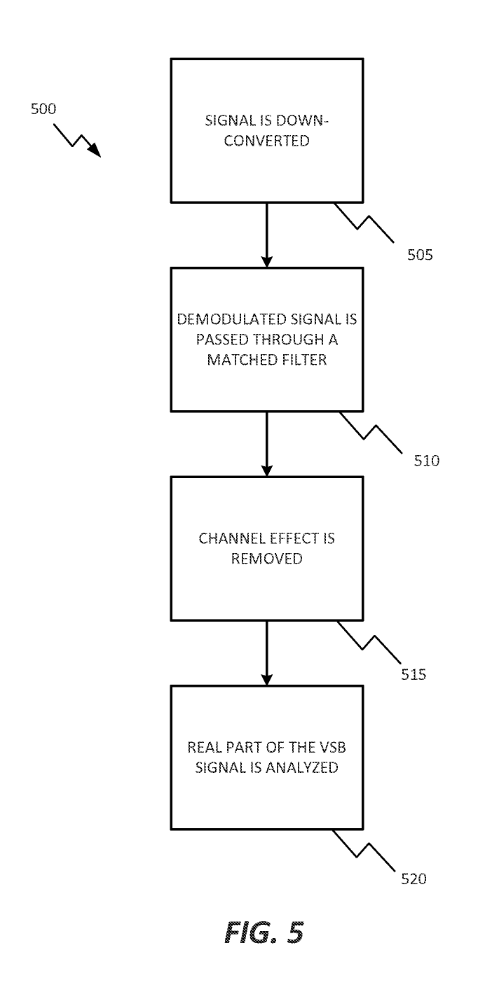

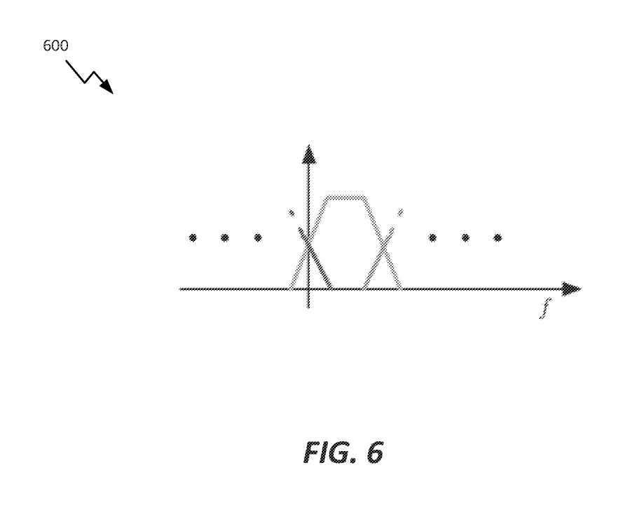

FIG. 5 illustrates a demodulation process 500 of each subcarrier in CMT. Although illustrated as occurring in a sequential order, it should be understood that the order of the steps disclosed in process 500 may vary. Furthermore, additional steps may be included in the process 500 and not all of the steps may be required. For each subcarrier (1^{st} subcarrier, 2^{nd} subcarrier, . . . k^{th} subcarrier), the received signal is down-converted to baseband using fₖ as the carrier frequency (Step 505). Step 505 results in a spectrum 600 of FIG. 6. The demodulated signal is passed through a matched filter that extracts the desired VSB signal at the baseband (Step 510). The matched filter removes most of the signal spectra from other subcarriers. However, in some embodiments, some residual signal spectra from adjacent subcarriers may remain. The channel effect is removed from the demodulated signal using a complex-valued single tap equalizer (Step 515). Step 515 is based on the assumption that each subcarrier band is sufficiently narrow such that it can be approximated by a flat gain. In some embodiments, a multi-tap equalizer may be adopted if this approximation is invalid. After equalization, the real part of the VSB signal contains the desired PAM symbol only (Step 520). The imaginary parts of the VSB signal include a mix of intersymbol interference (ISI) components and intercarrier interference (ICI) components from the two adjacent subcarrier bands. Accordingly, taking the real part of the equalized VSB signal delivers the desired data signal/symbol, free of ISI and ICI.

The CMT modulation process discussed above can be used in conjunction with the network 100. Each terminal 110 is distinguished by the base station 105 by the respective subcarrier gains between the individual terminal receiver/transmitters 115 and the plurality of base station receiver/transmitters 120. A transmit symbol sₖ from the k^{th} terminal 110 arrives at the base station 105 as a vector xₖ, illustrated by Equation [1] below:

xₖ=(sₖ+jqₖ)*hₖ [1]

Where hₖ is the channel gain vector and qₖ is a contribution from ISI and ICI (* denotes element-by-element multiplication of two vectors). The vector xₖ and similar contributions from other individual terminals 110, as well as channel noise, add up to form the base station received signal vector, illustrated by Equation [2] below:

$$x = {\sum }_{k = 0}^{K - 1} {x}_{k} + v , \qquad [ 2 ]$$

where v is the channel additive noise.

The base station 105 uses a set of linear estimators that all take x as their input and provide the estimates of the users data symbols s₀, s₁, . . . , s_{K-1} at the output. The following mathematical formulas (Equation [3] and Equation [4]) illustrate two different embodiments of linear estimators. In such embodiments, it may be assumed that

$$\tilde{x} = {[ \begin{matrix}{x}_{R}^{T} & {x}_{I}^{T}\end{matrix} ]}^{T} ;$$

$$\tilde{v} = [ \begin{matrix}{v}_{R}^{T} & {v}_{I}^{T}\end{matrix} ] \text{?} ; {\tilde{h}}_{k} = {[ \begin{matrix}{h}_{k , R}^{T} & {h}_{k , 1}^{T}\end{matrix} ]}^{T} ; {\breve{h}}_{k} = {[ \begin{matrix}- h \text{?} & \text{?}\end{matrix} ]}^{T} ;$$

$$s = {[ \begin{matrix}{s}_{0} & {s}_{1} & … & {s}_{K - 1}\end{matrix} ]}^{T} ; and q = {[ \begin{matrix}{q}_{0} & {q}_{1} & … & {q}_{K - 1}\end{matrix} ]}^{T} . \\ \text{?} \text{indicates text missing or illegible when filed}$$

Thus, Equation [2] can be rearranged as Equation [3] below:

$$\tilde{x} = \tilde{H} s + \breve{H} q + \tilde{v} \qquad [ 3 ]$$

Where the H's are matrices with columns of h₀, h₁, . . . , h_{K-1}, respectively. Equation [3] can then be rearranged as Equation [4] below:

$$\tilde{x} = A [ \begin{matrix}s \\ q\end{matrix} ] + \tilde{v} , where A = [ \tilde{H} \breve{H} ] . \qquad [ 4 ]$$

In some embodiments, the matched filter detector obtains an estimate of sₖ according to Equation [5] below:

$${\hat{s}}_{k} = {( {\tilde{h}}_{k}^{T} {\tilde{h}}_{k} )}^{- 1} {\tilde{h}}_{k}^{T} \tilde{x} . \qquad [ 5 ]$$

Thus, when the number of base station receiver/transmitters 120 increase to infinity, the multiuser interference and noise effects vanish to zero. In embodiments where the number of base station receiver/transmitters 120 are finite, the matched filter estimator is not optimal. Therefore, a second estimator is obtained according to Equation [6] below:

$${\hat{s}}_{k} = {w}_{k}^{T} \tilde{x} \qquad [ 6 ]$$

Where wₖ is chosen to minimize the cost function (i.e., the mean-squared value of the estimate) (represented in Equation [7] below). Using Equation [6] above maximizes the signal-to-interference-plus-noise (SINR). Following the standard derivations, the optimum choice of wₖ is obtained as Equation [8] below. In Equation [8] below, it is assumed that the elements of the noise vector v are independent and identically distributed.

$$\begin{matrix}ζ = 𝔼 [ {( {s}_{k} - {\hat{s}}_{k} )}^{2} ] & [ 7 ] \\ {w}_{k , o} = {( {AA}^{T} + {σ}_{υ}^{2} I )}^{- 1} {\tilde{h}}_{k} & [ 8 ]\end{matrix}$$

In another embodiment, wₖ may be initialized to the matched filter estimator. A blind estimator (constructed based on Equation [7]) or a decision directed LMS algorithm could then be performed to fine tune wₖ.

Combination (Step 215 of FIG. 2) includes the combination of the signal components, of the different channels. This combination smoothes channel distortion, thus resulting in an approximately flat gain. As discussed above, combination, in some embodiments, includes linear combination of the subcarriers.

In some embodiments, the network 100 may be a non-cooperative multi-cellular time-division duplex (TDD) network. In such embodiments, the network 100 may suffer from a pilot contamination problem. This occurs due to the channel reciprocity. In such networks, the channel state information (CSI) is obtained at the base station 105 during an uplink transmission. Practical limitations do not allow utilization of orthogonal pilot sequences in different cells, and as a consequence the non-orthogonal pilots of neighboring cells will contaminate the pilots of each other. Thus, the channel estimates at each of the plurality of base stations 105 in different cells will contain the channel information of not only the terminals 110, which are located in the base station's own vicinity (i.e., the individual cell), but will also contain the channel information of terminals 110, which are located in the vicinity of other base stations 105 (i.e., other cells). As a result, when the base station 105 linearly combines the received signals in order to decode the transmitted symbols of its own terminals 110, it also combines the data symbols of terminals 110 in the vicinity of other base stations 105, which results in inter-cell interference.

The blind adaptation algorithm that are built based on the cost function [7] may be used to remove the pilot contamination effects, by improving on the linear combiner gains at the base stations 105. Performing the blind adaptation algorithm may improve the linear combining induced channel equalization.

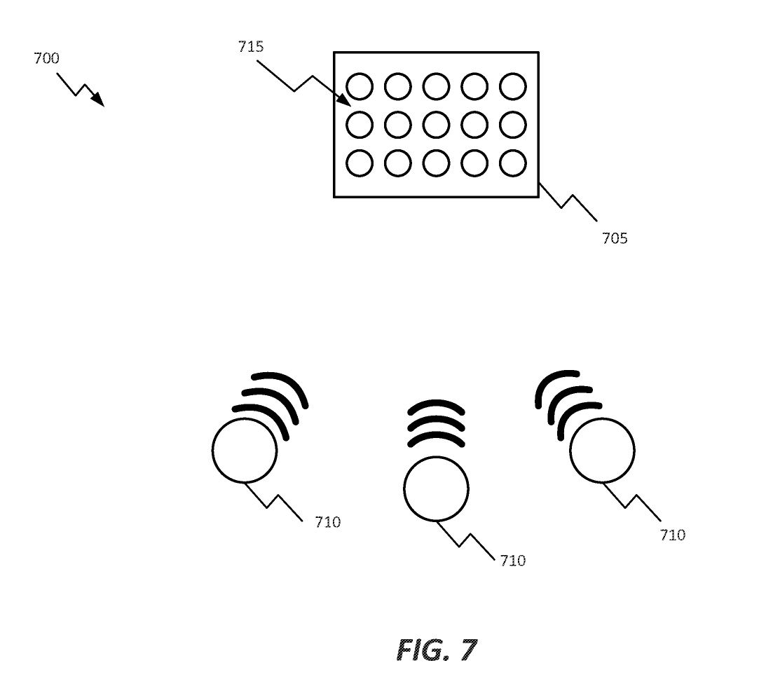

FIG. 7 illustrates another embodiment of the invention having an underwater network 700. The underwater network 700 may include a base station, or fusion center, 705 and a plurality of individual terminals, or individual sensors, 710. In some embodiments, the individual terminals 710 may be transducers. The fusion center 705 may include a plurality of base station sensors, or receiving sensors, 715. In some embodiments, the base station sensors 715 may be hydrophones. In other embodiments, the base station sensors 715 may be transducers, such as, but not limited to, acoustic transducers. The underwater network 700 may operate in a substantially similar manner to the network 100 described above.

In some embodiments, an initial estimate of the channel gains between the individual terminals 710 and the fusion center 705 are obtained through a set of pilot tones at the beginning of each communication session. In such embodiments, a blind adaptation algorithm, as discussed above, can be used to track channel variations. The blind adaptation algorithm may run without any need for pilot symbols. Typically, a large number of pilots are used for tracking of the channel variations. The use of the proposed blind tracking algorithm has the advantage, among other things, of increasing the bandwidth efficiency of the underwater network 700.

Thus, this disclosure provides, among other things, a multi-user network including a base station and a plurality of individual terminals. Various features and advantages of the networks disclosed herein are set forth in the following claims.

What is claimed is:

1. A multi-user network comprising:
a plurality of individual terminals, wherein each individual terminal includes a terminal receiver/transmitter; and
a base station including a plurality of base station receiver/transmitters, wherein the number of base station receiver/transmitters is greater than the number of individual terminals, the base station configured to
communicate simultaneously with the plurality of individual terminals over a plurality of channels, the plurality of channels each including a signal component,
filter the signal components, and
combine the signal components;
wherein each channel corresponds to an individual terminal; and
wherein combining the plurality of signal components results in a substantially flat gain.

2. The multi-user network of claim 1, wherein the signal components are linearly combined.

3. The multi-user network of claim 1, wherein the plurality of individual terminals are cellular devices.

4. The multi-user network of claim 1, wherein the terminal receiver/transmitters and the base station receiver/transmitters are cellular antennas.

5. The multi-user network of claim 1, wherein a blind adaptation algorithm is used to remove pilot contamination effects.

6. A multi-user network comprising:
a plurality of individual terminals, wherein each individual terminal includes a terminal receiver/transmitter; and
a base station including a plurality of base station receiver/transmitters, wherein the number of base station receiver/transmitters is greater than the number of individual terminals;
wherein communication between the plurality of individual terminals and the base station is encoded using a filter bank multicarrier method.

7. The multi-user network of claim 6, wherein the filter bank multicarrier method removes pilot contamination effects.

8. The multi-user network of claim 6, wherein the filter bank multicarrier method includes
processing the communication over a plurality of channels, the plurality of channels each including a signal component; and
combining the signal components;
wherein combining the signal components results in a substantially flat gain.

9. The multi-user network of claim 8, wherein the signal components are linearly combined.

10. The multi-user network of claim 6, wherein the plurality of individual terminals are cellular devices.

11. The multi-user network of claim 6 wherein the terminal receiver/transmitters and the base station receiver/transmitters are cellular antennas.

12. A multi-user network comprising:
a plurality of individual terminals, wherein each individual terminal includes a terminal sensor; and
a base station including a plurality of base station sensors, wherein the number of base station sensors is greater than the number of individual terminals, the base station configured to
communicate simultaneously with the plurality of individual terminals over a plurality of channels, the plurality of channels each including a signal component,
filter the signal components, and
combine the signal components;
wherein each channel corresponds to an individual terminal; and
wherein combining the plurality of signal components results in a substantially flat gain.

13. The multi-user network of claim 12, wherein the signal components are linearly combined.

14. The multi-user network of claim 12, wherein the terminal sensors are acoustic transducers.

15. The multi-user network of claim 12, wherein the base station sensors are acoustic transducers.

16. The multi-user network of claim 12, wherein a blind adaptation algorithm is used to remove pilot contamination effects.

17. A multi-user network comprising:
a plurality of individual terminals, wherein each individual terminal includes a terminal sensor; and
a base station including a plurality of base station sensors, wherein the number of base station sensors is greater than the number of individual terminals;
wherein communication between the plurality of individual terminals and the base station is encoded using a filter bank multicarrier method.

18. The multi-user network of claim 17, wherein the filter bank multicarrier method removes pilot contamination effects.

19. The multi-user network of claim 17, wherein the terminal sensors are acoustic transducers.

20. The multi-user network of claim 17, wherein the base station sensors are acoustic transducers.

21. The multi-user network of claim 17, wherein the filter bank multicarrier method includes
processing the communication over a plurality of channels, the plurality of channels each including a signal component; and
combining the signal components;
wherein combining the signal components results in a substantially flat gain.

22. The multi-user network of claim 21, wherein the signal components are linearly combined.

23. A multi-user network comprising:
a plurality of individual terminals, wherein each individual terminal includes a terminal receiver/transmitter; and
a base station including a plurality of base station receiver/transmitters, wherein the number of base station receiver/transmitters is greater than the number of individual terminals;
wherein a blind adaptation algorithm is used to remove pilot contamination effects.

24. The multi-user network of claim 23, wherein communication between the plurality of individual terminals and the base station is encoded using a filter bank multicarrier method.

25. The multi-user network of claim 24, wherein the filter bank multicarrier method includes
processing the communication over a plurality of channels, the plurality of channels each including a signal component; and
combining the signal components;
wherein combining the signal components results in a substantially flat gain.

26. The multi-user network of claim 25, wherein the signal components are linearly combined.

27. A multi-user network comprising:
a plurality of individual terminals, wherein each individual terminal includes a terminal sensor; and
a base station including a plurality of base station sensors, wherein the number of base station sensors is greater than the number of individual terminals;
wherein a blind adaptation algorithm is used to remove pilot contamination effects.

28. The multi-user network of claim 27, wherein communication between the plurality of individual terminals and the base station is encoded using a filter bank multicarrier method.

29. The multi-user network of claim 28, wherein the filter bank multicarrier method includes
processing the communication over a plurality of channels, the plurality of channels each including a signal component; and
combining the signal components;
wherein combining the signal components results in a substantially flat gain.

30. The multi-user network of claim 29, wherein the signal components are linearly combined.
